(19) United States
(12) Patent Application Publication
(10) Pub. No.: US 2019/0247775 A1
(43) Pub. Date: Aug. 15, 2019

(54) FILTER ASSEMBLY WITH SALT FILTER

(71) Applicant: Fontana Holdings, LLC, Hampshire, IL (US)

(72) Inventors: Daniel E. Schuld, Inverness, IL (US); Margaret M. Schuld, Inverness, IL (US)

(21) Appl. No.: 15/896,271

(22) Filed: Feb. 14, 2018

(51) Int. Cl. B01D 46/00; B01D 39/16; B01D 39/06; B01D 46/52; B03C 3/013

(52) U.S. Cl. CPC B01D 46/0023; B01D 46/0032; B01D 39/1615; B03C 3/013; B01D 39/06; B01D 46/525; B01D 46/0002; B01D 39/1623

(57) ABSTRACT

A filter media layer and a filter support layer are generally parallel and coextending. A frame holds the filter media layer and the filter support layer. Salt is deposited on at least one substrate in the airflow, where the substrate is at least one of the filter media layer, the filter support layer, a portion of the frame that is exposed to the airflow, or a separate receiving structure.

### FIELD OF THE INVENTION

The present invention relates to filters, and more specifically, the present invention relates to filter assemblies for furnaces that reduce airborne particles.

### BACKGROUND OF THE INVENTION

Furnace filters protect a furnace from the particles that pass through it that could potentially clog the furnace and prevent the furnace from working at its optimum level. If the interior of the furnace is not kept free of dust and particles, its internal mechanisms and coils can become dirty and over time, the furnace can operate less efficiently and require costly repairs.

Furnace filters also reduce the level of loose particles in the air. Common household activities such as dusting, vacuuming, cooking and smoking can introduce airborne particles that can impact the health of those breathing the particles. Some common symptoms include allergic reactions, asthma, eye irritation, and other infectious diseases.

### SUMMARY OF THE INVENTION

In an embodiment, a filter media layer and a filter support layer are generally parallel and coextending. A frame holds the filter media layer and the filter support layer. Salt is deposited on at least one substrate in the airflow, where the substrate is at least one of the filter media layer, the filter support layer, a portion of the frame that is exposed to the airflow, or a separate receiving structure.

In another embodiment, a filter assembly includes a media filter having a filter media layer and a filter support layer. The filter assembly also includes a salt filter having a honeycomb matrix. The salt filter has salt contained within a receiving area in the honeycomb matrix.

Another filter assembly includes a filter media layer, a filter support layer downstream of the filter media layer, and a honeycomb matrix upstream of the filter media layer. The salt filter includes salt contained within a receiving area in the honeycomb matrix. A sleeve at least partially encloses the filter media layer, the filter support layer and the honeycomb matrix.

### BRIEF DESCRIPTION OF THE DRAWINGS

The drawings are merely exemplary of one or more embodiments of the present invention in which:

FIG. 1 is a rear perspective view of filter assembly having a media filter and a salt filter;

FIG. 2 is a partial front perspective view of the filter assembly of FIG. 1, with an exploded view of the media filter and the salt filter;

FIG. 3 is a detail view of salt pellets; and

FIG. 4 is a detail view of the salt filter containing the salt pellets of FIG. 3.

### DETAILED DESCRIPTION OF THE INVENTION

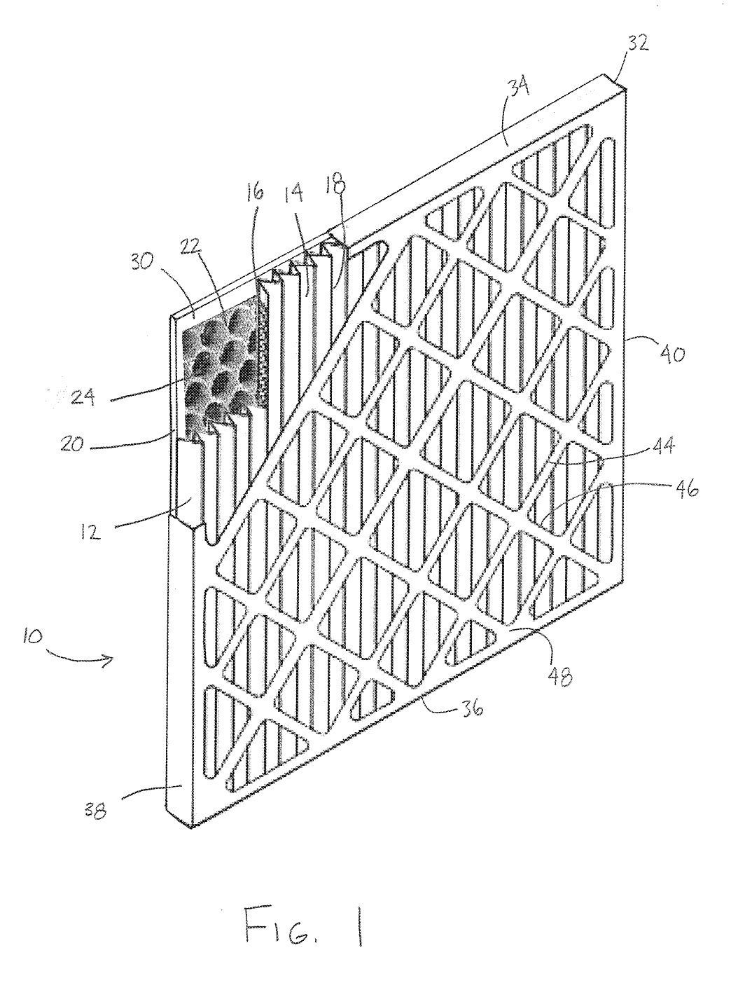

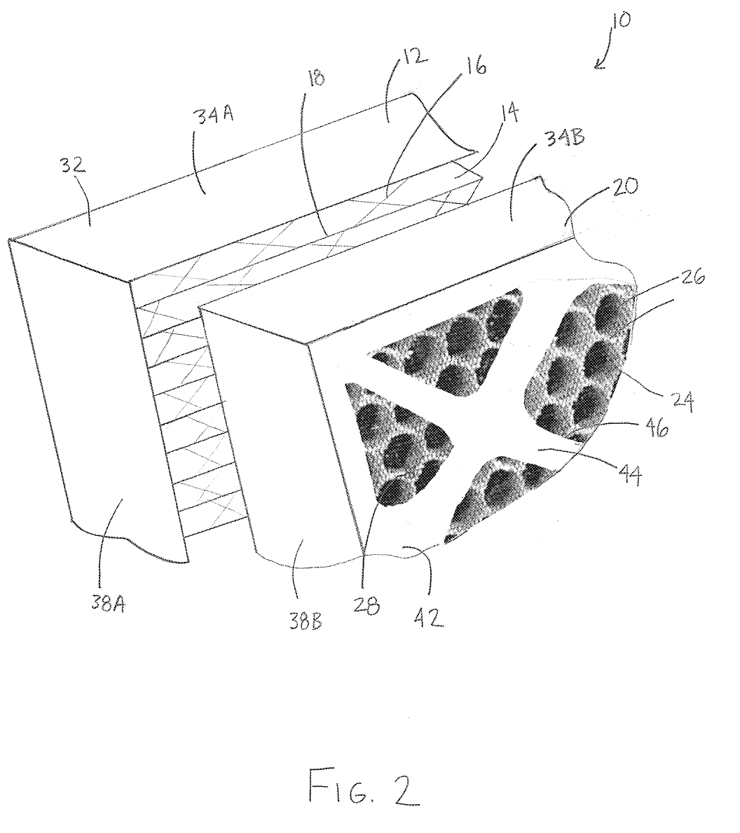

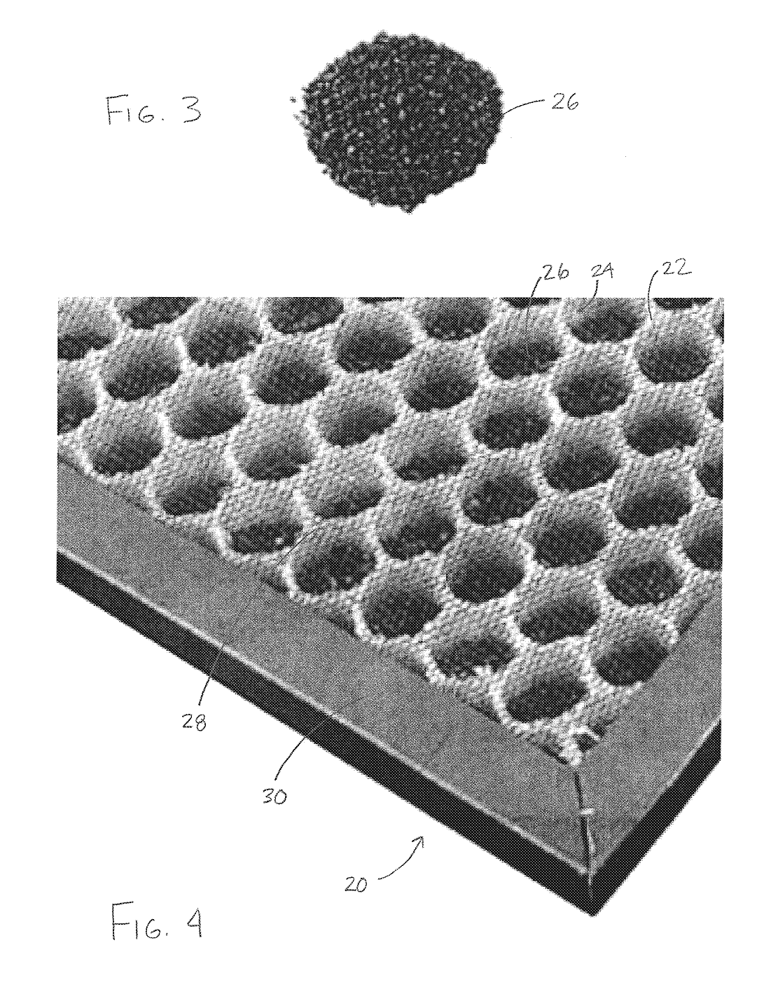

Referring now to FIGS. 1-2, a filter assembly 10, such as a pleat pack filter, preferably includes a media filter 12 having filter media layer 14 and a filter support layer 16. As is well known in the art, the filter media layer 14 may be made of non-woven natural or synthetic fibers capable of extracting impurities from the air. However, the filter media layer 14 can be made of other known or later-developed materials.

The filter support layer 16 is porous and flexible and is preferably fabricated from slit and expanded metal foil. However, the filter support layer 16 could be made of plastic or other material. The filter support layer 16 is more rigid than the filter media layer 14 and is preferably positioned on the downstream side of the filter media layer in the direction of airflow. Airflow is generally perpendicular to the plane of the filter assembly 10. The filter support layer 16 provides support to the filter media layer 14 to maintain a generally pleated shape of the media filter 12. In the pleated shape, the filter media layer 14 defines generally parallel pleat edges 18.

As seen in FIG. 2 and FIG. 4, the pleat pack filter 10 also preferably includes a salt filter 20 having a honeycomb matrix 22 formed of plastic, however other materials are contemplated. Receiving areas 24 are positioned throughout the honeycomb matrix 22. The receiving areas 24 are preferably apertures extending through the honeycomb matrix 22, however it is possible that the receiving areas are recesses. Salt 26, preferably in pellet form, is deposited into the receiving areas 24 of the honeycomb matrix 22. The salt 26 is preferably Himalayan crystal salt, but any other salt is contemplated. The salt 26 may also be mixed with one or more additives to fix the pellets together and/or adhere to the honeycomb matrix 22 and/or the receiving areas 24.

In another embodiment, the salt filter 20 can be incorporated into the media filter 12, such as by sectioning off a portion of the filter media layer 14 and substituting the filter media layer 14 with a deposit of salt 26 onto a substrate that is a separate receiving substrate. Alternatively, a thin layer of salt 26 can be deposited directly onto a substrate such as the filter media layer 14, the filter media support 16, or a portion of the frame 30 that is exposed to airflow, such that the media filter 12 and the salt filter 20 are combined.

A mesh 28 is positioned generally parallel with the honeycomb matrix 22, the mesh being located adjacent both the upstream side of the matrix and the downstream side of the matrix to maintain the salt 26 within the receiving areas 24. Preferably, the mesh 28 is laid across and contacts the structure of the honeycomb matrix 22 to enclose the receiving areas 24. A frame 30 may be used to enclose and assemble the components of the salt filter 20, and the mesh 28 may be glued or otherwise affixed to honeycomb matrix 22 and/or the frame. Wicking paper may be added to the frame 30.

The pleat pack filter 10 includes a box-shaped sleeve 32, which preferably includes four end caps 34, 36, 38, 40 at the top, bottom and two side ends respectively, of the pleat pack filter 10. An upstream surface 42 of the box-shaped sleeve 32 has a web 44 with openings 46. It is also contemplated that a downstream surface 48 of the box-shaped sleeve 18 also has a web 44 with openings 46. As shown in the exploded view of FIG. 2, the end caps 34A, 38A of the media filter 12 cooperate with the end caps 34B, 38B of the salt filter 20 like a gift-box to form the sides 34, 36, 38, 40 of the sleeve. The sides of the sleeve 32 may be may be fixed together with adhesive, by a mechanical attachment, or any other known methods. While other materials are contemplated, the sleeve 32 is preferably formed of paper or cardboard.

The filter assembly 10 is designed to be received in a furnace having a frame enclosure (not shown). The frame enclosure includes a top wall, a bottom wall, a rear wall, and an opposite wall (not shown). The four walls define a generally rectangular air passageway in which the filter assembly 10 is transversely positioned. Consequently, air is directed to flow through an upstream surface 42 of the filter assembly 10 and out of the downstream surface 48 of the filter assembly 10.

When the filter assembly 10 is used in the furnace, the salt 26 deposited in the salt filter 20 reacts to the heat output of the furnace to produce negative ions. When negative ions are emitted, they are statically attracted to airborne particles like dust, mold and other pollutants and allergens. The negative ions attach to the airborne particles and give them a negative charge, and consequently, the airborne particles are grounded and fall to the floor/nearest surface. In a ventilated space, these airborne particles are circulated through the space and returned by the forced air system to the furnace. When air is returned to the furnace and directed through the filter assembly 10, the negatively charged airborne particles are collected by the filter media layer 14. Since the filter assembly 10 is located adjacent the furnace, the output of heat from the furnace interacting with the salt generates the negative ions. An increase in the heat output will increase the rate at which negative ions are produced.

A test was conducted to determine whether salt on a filter assembly, in this instance a pleat pack filter, can product negative ions. Comparative testing was performed using a prototype 20″×25″×1″ pleated filter with Himalayan salt, and a conventional 20″×25″×1″ pleated filter without salt. The tests were conducted in a testing lab using a Goodman AEPF furnace at room temperature of 75-degrees Fahrenheit. All measurements were taken using a KT-401 air ion tester on the downstream side of the filter. The filter assembly that included the salt was measured as emitting 380 ions/cm², while the filter assembly without salt emitted less than 100 ions/cm². It was noted that an increase in heat and humidity at the furnace would result in a greater measurement of ions emitted from the filter including the salt.

While particular embodiments of the filter assembly 10 with a media filter 12 and salt filter 20 have been shown and described, it will be appreciated by those skilled in the art that changes and modifications may be made thereto without departing from the invention in its broader aspects and as set forth in the following claims.

What is claimed is:

1. A filter assembly comprising:
a filter media layer;
a filter support layer generally parallel and coextending with the filter media layer;
a frame holding the filter media layer and the filter support layer; and
salt deposited on at least one substrate in the airflow, wherein the substrate is at least one of the filter media layer, the filter support layer, a portion of the frame that is exposed to the airflow, or a separate receiving structure.

2. The filter assembly of claim 1, wherein the salt filter further comprises a honeycomb matrix with receiving structures.

3. The filter assembly of claim 2 wherein the receiving structures contain the salt.

4. The filter assembly of claim 3 further comprising a mesh fixed to the honeycomb structure for containing the salt within the receiving structures.

5. The filter assembly of claim 1 wherein the filter media layer is formed of non-woven natural or synthetic fibers capable of extracting impurities from the air.

6. The filter assembly of claim 1 further comprising a sleeve having a top end cap, a bottom end cap, and two side end caps, wherein said sleeve encloses both the media filter and the salt filter.

7. The filter assembly of claim 6 wherein the sleeve further comprises an upstream surface having at least one web and at least one opening.

8. The filter assembly of claim 1 wherein the substrate is the filter media layer.

9. The filter assembly of claim 1 wherein salt filter is positioned upstream of the media filter.

10. A filter assembly comprising:
a media filter including a filter media layer and a filter support layer; and
a salt filter including a honeycomb matrix, wherein the salt filter includes salt contained within a receiving area in the honeycomb matrix.

11. The filter assembly of claim 10 wherein the salt filter is located upstream of the media filter.

12. The filter assembly of claim 10 wherein the filter media layer is formed of non-woven natural or synthetic fibers capable of extracting impurities from the air.

13. The filter assembly of claim 10 further comprising a mesh fixed to the honeycomb structure for containing the salt within the receiving structures.

14. The filter assembly of claim 10 further comprising a sleeve having a top end cap, a bottom end cap, and two side end caps, wherein said sleeve partially encloses both the media filter and the salt filter.

15. The filter assembly of claim 14 wherein the sleeve further comprises an upstream surface having at least one web and at least one opening.

16. The filter assembly of claim 15 wherein the sleeve is formed of paper.

17. The filter assembly of claim 10 wherein the salt is Himalayan crystal salt.

18. A filter assembly comprising:
a filter media layer;
a filter support layer downstream of said filter media layer;
a honeycomb matrix upstream of said filter media layer, wherein the salt filter includes salt contained within a receiving area in the honeycomb matrix; and
a sleeve that at least partially encloses the filter media layer, the filter support layer and the honeycomb matrix.

19. The filter assembly of claim 18 further comprising a mesh fixed to the honeycomb structure for containing the salt within the receiving structures.

20. The filter assembly of claim 18 wherein the salt is Himalayan crystal salt.
